(19) United States
(12) Patent Application Publication
(10) Pub. No.: US 2006/0259490 A1
(43) Pub. Date: Nov. 16, 2006

(54) Document management system, document management method, and recording medium storing program for document management

(76) Inventors: Kazunori Horikiri, Tokyo (JP); Masatomi Inagaki, Tokyo (JP); Yoshiki Watanabe, Tokyo (JP); Eriko Tamaru, Yokohama-shi (JP); Hitoshi Abe, Tokyo (JP)

Correspondence Address: GAUTHIER & CONNORS, LLP, 225 FRANKLIN STREET, BOSTON, MA, 02110, US

(21) Appl. No.: 11/268,347

(22) Filed: Nov. 7, 2005

(30) Foreign Application Priority Data
Apr. 28, 2005 (JP) 2005-130993

(51) Int. Cl. G06F 17/30

(52) U.S. Cl. 707/9

(57) ABSTRACT

A multifunction device transmits an acquisition request including a user ID read from an IC card by a card reader to acquire data identifying a conference to which a user belongs from an information management server; automatically produces attribute information including a scanner ID, a time when the scanning was performed, and a location; and adds the information to a scanned document to register the information in a scanned document management server. An information terminal device transmits an acquisition request including a user ID read from an IC card by a card reader to acquire from an information management server information such as a conference to which the user belongs, a conference member, and a conference place. Moreover, the acquired information is compared with attribute information of each scanned document registered in the scanned document management server to select the scanned document to be downloaded onto the information terminal device.

### BACKGROUND OF THE INVENTION

(i) Field of the Invention

The present invention relates to a document scan management system and, more particularly, to acquisition of document data using a document scanning unit such as a scanner.

(ii) Description of the Related Art

In recent years, convenience and security of multifunction devices have been improved through addition of functions such as a scanner function, a privacy function, a network function, and the like in such multifunction devices. Because this increased functionality increases the applications and utility of the devices, it has become common for multifunction devices to be installed at locations other than office environments. For example, a multifunction device provided in a conference room may be used to scan a paper document for distribution to participants at a conference, or to convert the printed data to electronic data for editing. As a result, efficiency of the conference can be increased. In a case where attribute information such as user information on a document owner is to be added to a document scan (scanned document) read by a scanner or the like and converted into electronic data, the attribute information has heretofore been input from a terminal disposed in combination with the scanner or an attribute sheet in which the attribute information is set is read together with the document scan, and the scanned document is associated with the attribute information.

In an example wherein a certain user wishes to upload the scanned document of conference data (paper document) into their personal computer (PC) using a multifunction device installed in a conference room in preparation for a conference at another facility of the company at which the user is employed. In this case, the user first obtains digital data for the paper document using the scanner function of the multifunction device. Then, the user verifies the model and the network address of the devices, installs on their PC a driver usable for that model of multifunction device, and sets the appropriate network address. Furthermore, for security considerations, the user prepares a confidential box in the multifunction device, or obtains information (user ID, password, etc.) required for utilizing an existing confidential box.

However, obtaining appropriate information on the multifunction device, setting up the user's PC, and the like are laborious and unrealistic tasks. In addition, there is also a possibility that the user may not be able to properly set up their PC because they cannot obtain all the required information. For example, in the above-described conference, it can be imagined that the conference participants may wish to extract data from multiple participants, not just the single user described above.

In a conventional system, the user disadvantageously has to repeat operations of inputting and setting the attribute information as required for the multiple sources. An ability to read a document using a scanner function or the like of the multifunction device and to acquire the scanned document data with a simple operation, regardless of location where the reading or the acquiring is performed, would advantageously enhance user convenience.

### SUMMARY OF THE INVENTION

The present invention has been developed in view of the above circumstances, and advantageously provides a document scan management system which is convenient for reading a document using a document scanning unit such as a scanner, and for otherwise acquiring or handling a document scan.

In order to achieve the above-described object, according to the present invention, there is provided a document management system which includes an information management unit that stores information regarding a user, a document input unit that inputs a document according to an instruction from a user, a first identification information acquiring unit that acquires identification information of the user who instructs to input the document, an attribute information generating unit which generates attribute information of the input document, the attribute information including at least one of the acquired user identification information and the stored user information, a document registration unit which registers the generated attribute information and the input document data, a second identification information acquiring unit that acquires identification information of a user who requires a registered document, and a request information transmission unit which transmits request information including at least one of the acquired user identification information and user information stored in the information management unit; and a document provision unit which provides document data related to the user based on the request information and the attribute information of the document data.

According to another aspect of the present invention, there is provided a document management method, which includes storing information regarding a user, inputting a document according to an instruction from a user, acquiring identification information of the user who instructs to input the document, generating attribute information of the input document, the attribute information including at least one of the acquired user identification information and the stored user information, registering the generated attribute information and the input document data, acquiring identification information of a user who requires a registered document, transmitting request information including at least one of the acquired user identification information and user information stored in the information management unit, and providing the document data related to the user based on the request information and the attribute information of the document data.

According to a further aspect of the present invention, there is provided a read document management method, which includes storing information regarding a user, inputting a document according to an instruction from a user, acquiring identification information of the user who instructs to input the document, generating attribute information of the input document, the attribute information including at least one of the acquired user identification information and the stored user information, registering the generated attribute information and the input document data, acquiring identification information of a user who requires a registered document, transmitting request information including at least one of the acquired user identification information and user information stored in the information management unit, and providing the document data related to the user based on the request information and the attribute information of the document data.

According to a further aspect of the present invention, there is provided a storage medium readable by a computer, the storage medium storing a program of instructions executable by the computer to perform a function as a document management server, the function includes storing information regarding a user, inputting a document according to an instruction from a user, acquiring identification information of the user who instructs to input the document, generating attribute information of the input document, the attribute information including at least one of the acquired user identification information and the stored user information, registering the generated attribute information and the input document data, acquiring identification information of a user who requires a registered document, transmitting request information including at least one of the acquired user identification information and user information stored in the information management unit, and providing the document data related to the user based on the request information and the attribute information of the document data.

According to a further aspect of the present invention, there is provided a document management system, which includes a document input unit that inputs a document along with information of a user who instructs the input, a document storage unit that stores the input document and the information of the user, a document requiring unit that requires a stored document which is related to a requiring user, using information of the requiring user, and a document provision unit that provides the requiring user with the document related to the requiring user based on the stored user information and information of the requiring user.

According to a further aspect of the present invention, there is provided a document management server, which includes a document storage unit that stores document data and information of a user who input the document data, and a document provision unit that receives a request from a user for a stored document which is related to the requesting user, and provides the requiring user with a document related to the requiring user based on the stored user information and information of the requiring user.

According to the present invention, even when environment setting is not performed in the computer for collecting information on the document reading unit or acquiring the document, the document data read from the document reading unit can be acquired with a simple operation.

Moreover, even when information on the user is not set or input, the information can be conveniently acquired automatically and added to the document data.

Furthermore, even document data prepared by another user, such as a member of the same conference who belongs to the same group, can be similarly acquired in the same manner as in the document data prepared by the user. On the other hand, because the document data that can be acquired is limited based on the user identification information, acquisition or use of document data by an unauthorized party can be prevented.

Even when plural document scan data exist, the scanned document supposed to be an acquisition object can be preferentially listed and displayed. Therefore, the document data can be easily selected.

### BRIEF DESCRIPTION OF THE DRAWINGS

A preferred embodiment of the present invention will be described in detail based on the following figures, wherein:

FIG. 1 is a diagram showing the overall configuration of an electronic conference system to which a document scan management system according to a preferred embodiment of the present invention is applied;

FIG. 2 is a block diagram of an electronic conference system according to the present embodiment;

FIG. 3 is a diagram showing an example of information held by a database of an information management server according to the preferred embodiment;

FIG. 4 is a flowchart showing processing related to scanning a document according to the preferred embodiment;

FIG. 5 is a diagram showing a data constitution of scanned document information registered in a scanned document information storage unit according to the preferred embodiment;

FIG. 6 is a flowchart showing example processing of the preferred embodiment when a scanned document is acquired; and

FIG. 7 is a diagram showing an example constitution of attribute information acquired by an information terminal device according to the preferred embodiment.

### DETAILED DESCRIPTION OF THE INVENTION

An embodiment of the present invention will be described hereinafter with reference to the drawings.

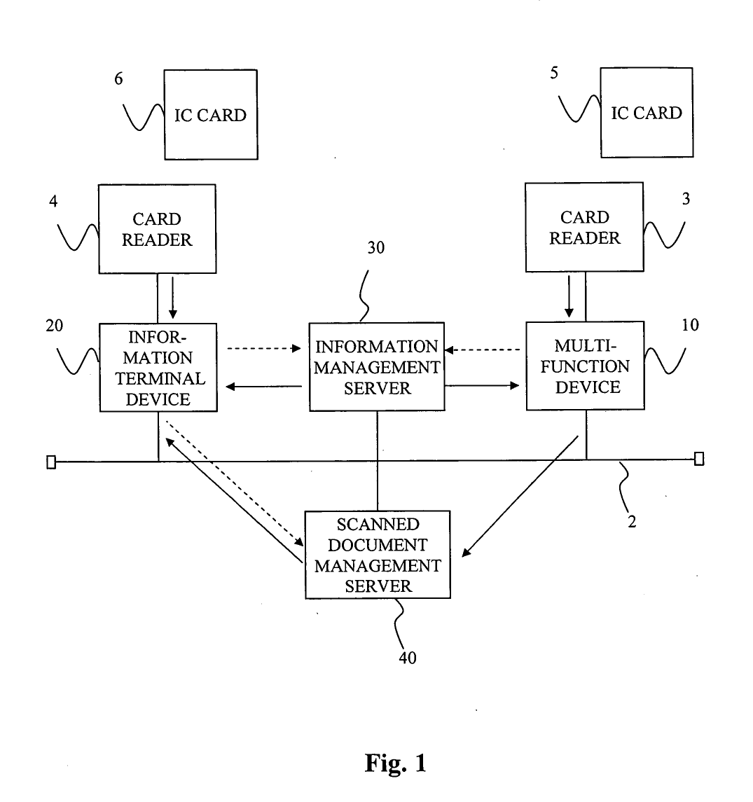

FIG. 1 is a diagram showing the overall configuration an example document scan management system according to this embodiment of the present invention. In the present embodiment, an example will be described in which the document scan management system is applied to an electronic conference system, such as that commonly known as a teleconferencing system. An electronic conference system as referred to in the present embodiment may be any system which handles electronic data by use of an information device such as a multifunction device or a PC. As the term is used in its broadest sense, it should not be presumed that a conference is performed between remote areas via a telephone circuit or a network. The electronic conference system in the present embodiment has a constitution in which a multifunction device 10, an information terminal device 20, an information management server 30, and a scanned document management server 40 are connected to one another via a local area network (LAN) 2. It is to be noted that in FIG. 1, “broken-line” arrows show paths of requests, and “solid-line” arrows show paths of information flow. The multifunction device 10 is an information device having a built-in computer provided with a scanner function, a network communication function, and the like in addition to a copying function, and is connected to a card reader 3. In the present embodiment, it is assumed that the system is installed in a conference room or in the vicinity of the room. The information terminal device 20 is a PC brought by a user or installed in the conference room, and is connected to a card reader 4. The information management server 30 stores and manages various information such as information on the user, information on a place where the multifunction device 10 is installed, and information on the conference room and the conference. The multifunction device 10 multifunction device 10 prepares attribute information based on information acquired from the information management server 30 or the like, and adds the attribute information to document data (scanned document) read by the multifunction device 10 to prepare document registration information. On the other hand, the scanned document management server 40 accumulates the document registration information sent from the multifunction device 10 in an internal document information database, to thereby store the information. The locations of the information management server 30 and the scanned document management server 40 are not especially limited, as long as the servers can be accessed from the conference room via the network. The respective card readers 3 and 4 read user identification information (hereinafter referred to as the “user ID”) recorded in IC cards 5 and 6, respectively.

Although a single multifunction device 10 is shown FIG. 1, it is assumed that a plurality of machines are connected to the LAN 2, depending on the number of conference rooms. The respective multifunction devices 10 have substantially similar constitutions. The information management server 30 holds various information in addition to user information as described in detail further below. Similarly, although only one information management server is shown in FIG. 1, the server may be constituted by a plurality of servers. Although the information management server 30 and the scanned document management server 40 are shown as separate servers because they hold different types of information, the two servers need not necessarily be separate devices.

Moreover, the network for connecting the respective computers is shown by the LAN 2, but the multifunction device 10 and the information terminal device 20 may be installed in distant places, and therefore a public network such as the Internet may be used. Plural LANs, or a combination of LANs and public networks, may be combined to constitute the network.

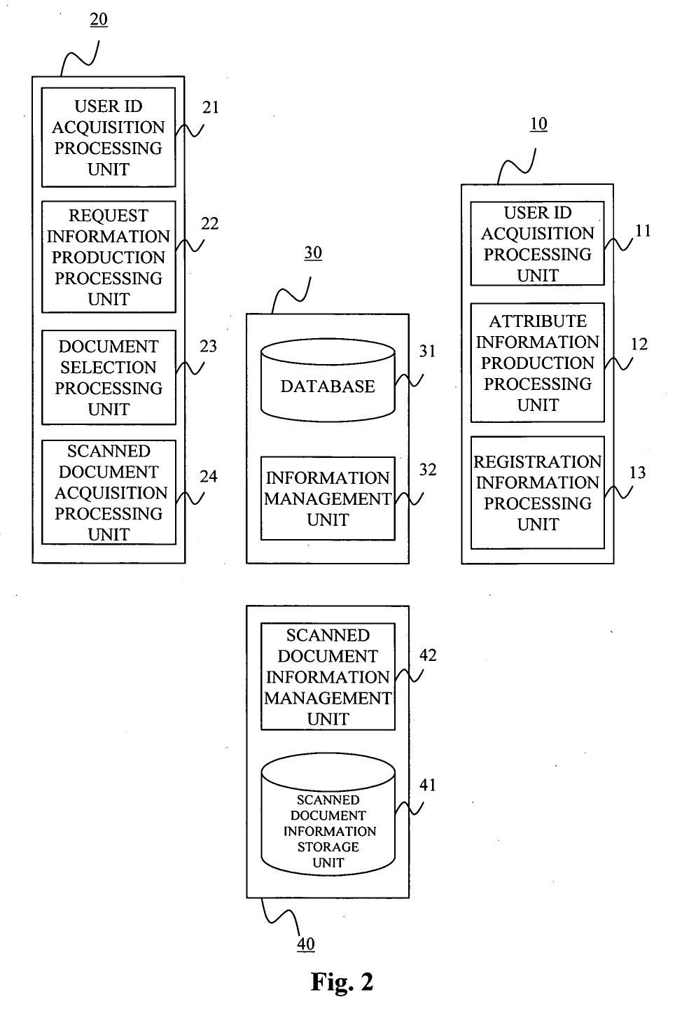

FIG. 2 is a block diagram of the electronic conference system in the present embodiment. The multifunction device 10 has a user ID acquisition processing unit 11, an attribute information production processing unit 12, and a registered information registration processing unit 13. It is to be noted that the multifunction device 10 obviously has a unit for performing processing of functions originally owned by the multifunction device, such as the copying function, the scanner function, and the network communication function. This is not illustrated or explained only as it is not a characteristic element of the present embodiment. Similarly, the other information devices 20, 30, and 40 are not explained.

The user ID acquisition processing unit 11 acquires a user ID read by the card reader 3. The attribute information production processing unit 12 acquires from the information management server 30 information such as the user information specified by the acquired user ID, and produces attribute information including the acquired information and the user ID. The registered information registration processing unit 13 adds the produced attribute information to the scanned document, and transmits the information to the scanned document management server 40 to thereby register the information. The processing functions of the respective units 11 to 13 are realized by cooperation of a computer of the multifunction device 10 and a CPU of the computer.

The information terminal device 20 has a user ID acquisition processing unit 21, a request information production processing unit 22, a document selection processing unit 23, and a scanned document acquisition processing unit 24. The user ID acquisition processing unit 21 acquires the user ID read by the card reader 4. The request information production processing unit 22 produces document acquisition request information for acquiring information required for uniquely specifying the scanned document extracted from the scanned document management server 40. The document selection processing unit 23 collates the document acquisition request information (attribute information) collected by the information terminal device 20 with each attribute information of the scanned document registered in the scanned document management server 40 to thereby the scanned document related to a document acquirer, that is, the scanned document regarded as an acquisition object by the document acquirer. The scanned document acquisition processing unit 24 extracts the selected scanned document from the scanned document management server 40.

The information management server 30 is a server computer which stores and manages information required for carrying out the electronic conference system, such as user information and scanner information described later. When, as described below, various types of information are missing, the missing information must be reconstructed, and can be assumed to be the existing information in an ordinary electronic conference system. This effective utilization of the existing information is regarded as one characteristic of the present embodiment. In FIG. 2, the information are integrated and shown as a database 31. An information management unit 32 extracts necessary information from the database 31 in response to requests from the multifunction device 10 and the information terminal device 20 to transmit the information. The information management unit manages the information held in the database 31 in this manner. A processing function of the information management unit 32 is realized by cooperation of the server computer with a program operated in the CPU mounted on the server computer.

The scanned document management server 40 is a sectional view which stores and manages the document registration information prepared by the multifunction device 10. The scanned document management server comprises a scanned document information storage unit 41 which stores the scanned document and the attribute information based on the document registration information sent from the multifunction device 10, and a scanned document information management unit 42 which performs management of information held by the scanned document information storage unit 41, such as registration of the information into the scanned document information storage unit 41 and the extracting and transmitting of the necessary information from the scanned document information storage unit 41 in response to the request from the information terminal device 20. The processing function of the scanned document information management unit 42 is realized by cooperation of the server computer with a program operated in the CPU of the server computer.

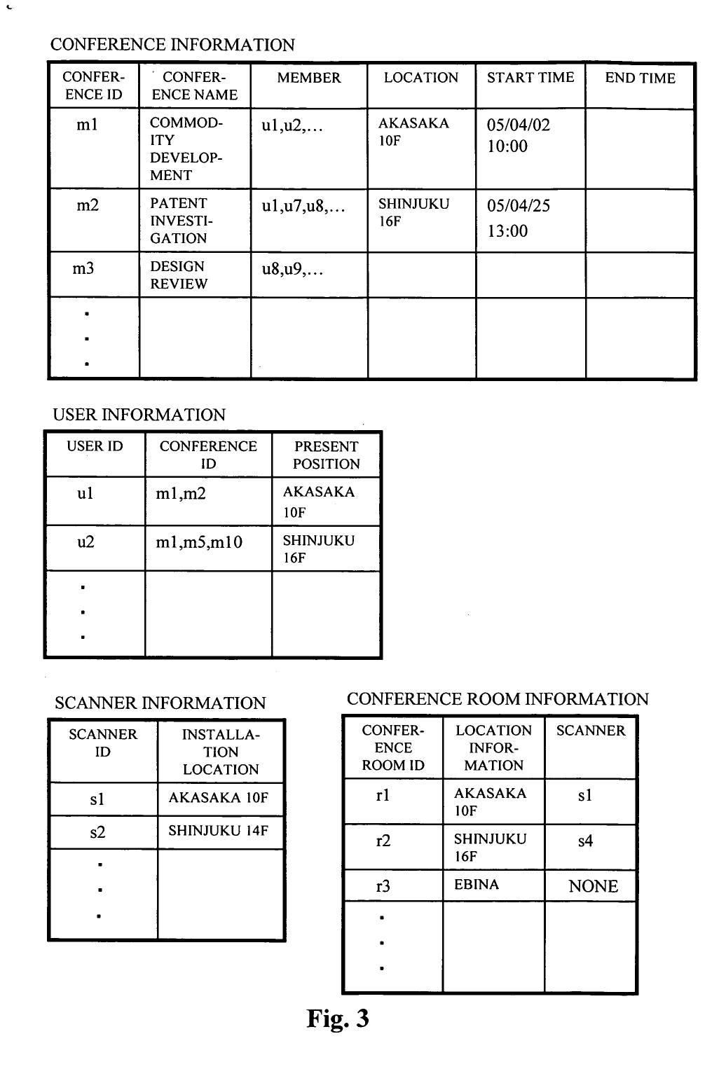

FIG. 3 is a diagram showing an example of information held by the database 31 of the information management server 30. FIG. 3 shows conference information, user information, and scanner information (conference room information). Here, “conference” refers to information for identifying a conference which the user has as a member. In FIG. 3, for each conference are registered identification information (hereinafter referred to as the “conference ID”) of the conference, a conference name, a list of members, a location, a start date, and an end date. Among them, in the conference name, there is set information which is text information for identifying the conference and which plainly represents purpose, agenda, and the like of the conference, such as “commodity development” and “design review”. For the member, the user ID of the user who has the conference is set. For the location, there is set a conference room in which the conference is being held or is scheduled. In the start date, there is set a date on which the conference has started or is scheduled to start. A blank means that the information has not been determined. In the end date, the end date of the conference is set. If the start date has been set and the end date has not been set, the conference is being held. When neither a start date nor an end date are set, the conference has not started yet. Obviously, flag information may be used which indicates that the conference is being held, scheduled, or finished. In the present embodiment, information on the conference and information on status of the conference are integrated and managed in a table for convenience, but may be managed in separate tables, respectively. Information on status of conference which has finished is accumulated in a history database (not shown).

For the user information, the user ID, the conference ID of the conference which the user has, and the user's present position information are associated and set. As shown in FIG. 3, it is a possible for a single user to have a plurality of conferences. Installed positions of the card readers 3 and 4 has been set beforehand, so the current location of each user can be obtained when their user ID is sent from any of the respective devices 10, 20 at a time of a reading operation of the IC card 5. The information on the conference which each user has may be handled as personal information such as their name and department (not shown). However, in the present embodiment, for convenience of description the user information is constituted as shown in FIG. 3.

In the scanner information are set scanner identification information (hereinafter referred to as the “scanner ID”) which can specify a scanner, and information on the location where the scanner is installed.

The conference room information includes a set of identification information (hereinafter referred to as the “conference room ID”) capable of specifying a conference room, information on where the conference room is located, and the ID of the scanner to be installed. It is to be noted that when each multifunction device 10 is installed in each conference room, the scanner information and the conference room information may be formed in a single table. It is to be noted that the information on the place is shown by characters as in, for example, “Akasaka 10F”, but may be longitude and latitude degree information to simplify distance calculations performed by the computer.

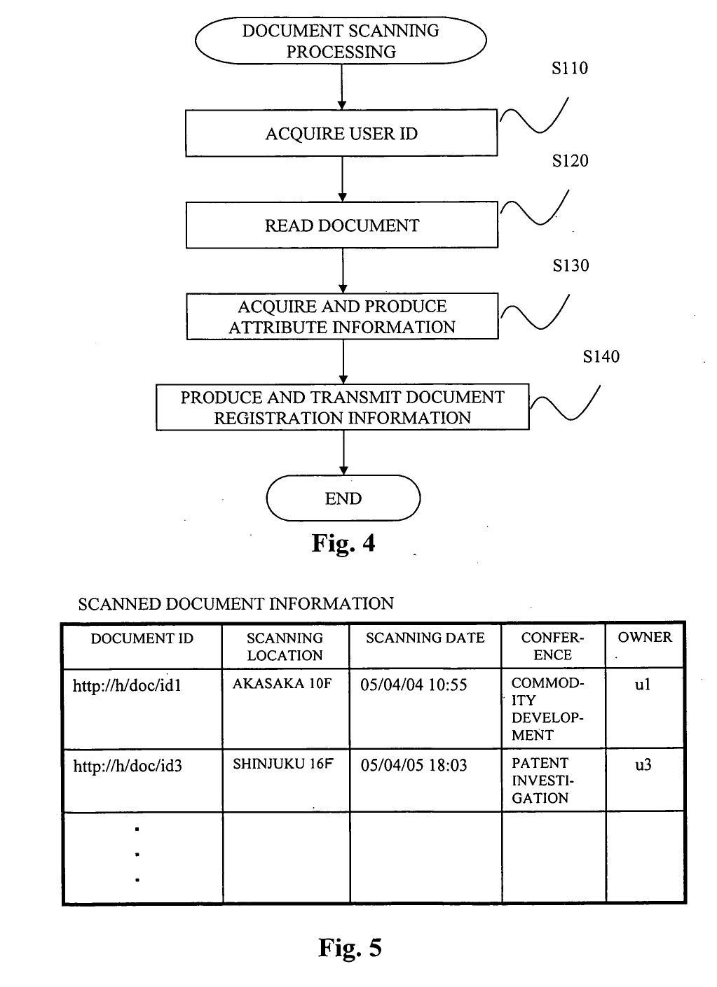

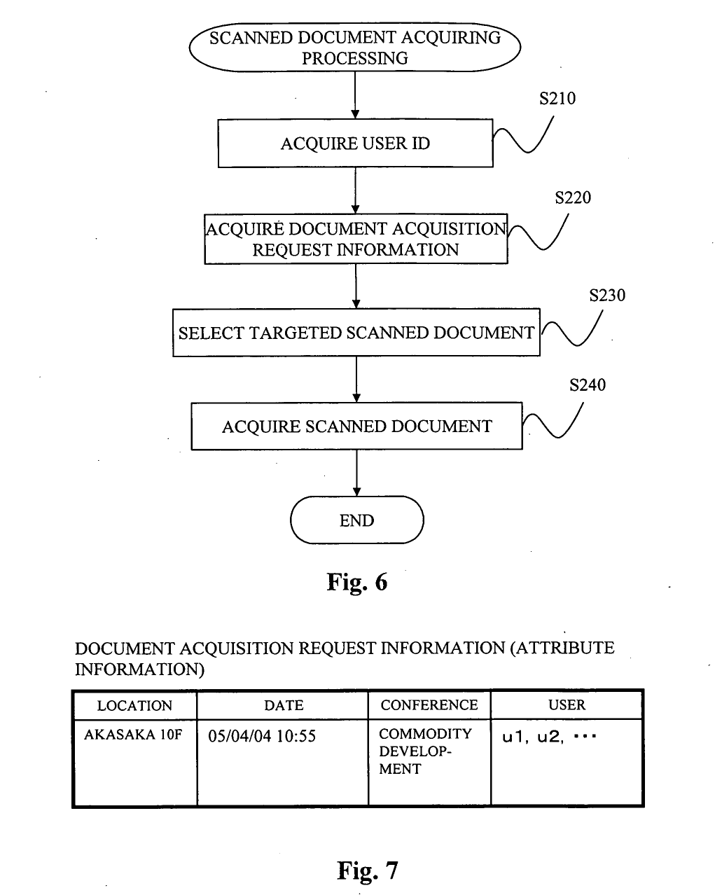

In the present embodiment, one of the characteristics is that the scanned document is held and managed by the scanned document management server 40 so that the information on a scanned document can be easily used in another conference room. However, in actual electronic conference systems to which the present embodiment is applied, there may be cases in which a single user scans multiple types of documents (conference data) or in which a scanned document registered by a user is to be shared with another member of the same conference. Therefore, in addition to applications in which a single user scans and retrieves a document at a single location, this embodiment of the invention may apply to cases wherein the scan and retrieval of a document are performed in different locations, or by different users. An operation of the present embodiment will be described hereinafter using an example in which the scanning and the retrieval of the document are performed at different locations, by different users. It is to be noted that the present embodiment can be roughly classified into a document scanning processing performed when the multifunction device 10 scans the document, and scanned document acquisition processing performed when the scanned document is retrieved for use. First, document scanning processing will be described with reference to the flowchart shown in FIG. 4.

In step 110, to scan a document, the user allows the card reader 3 connected to the multifunction device 10 installed in the conference room where the user is staying now to read the user's IC card 5. When the card reader 3 reads the user ID recorded in the IC card 5, the reader sends the user ID to the multifunction device 10. The user ID acquisition processing unit 11 of the multifunction device 10 acquires the user ID sent from the card reader 3 in this manner.

Next, in step 120, the user allows the multifunction device 10 to scan document using a scanner function.

In step 130, the attribute information production processing unit 12 transmits to the information management server 30 an information acquisition request including the scanner ID and the user ID held in the multifunction device 10.

When the information acquisition request is sent, the information management unit 32 in the information management server 30 searches the user information registered in the database 31 by using the user ID as a key to find the ID of the conference which the user has. The information management unit acquires the conference name specified by the conference ID. The unit also searches the scanner information by use of the scanner ID as the key to find the installation location information of the multifunction device 10. The information management unit 32 returns the information acquired in this manner to the multifunction device 10. Because the installation place of the multifunction device 10 is managed by the information management server 30, the user's present position can be updated by the user ID sent from the multifunction device 10.

When information is sent from the information management server 30 in response to the request, the attribute information production processing unit 12 in the multifunction device 10 produces information on the user, such as user ID and the conference, and information on document scanning, such as the scanner ID, the installation place information, and information of a date when the scanning was performed. In the present example, because the existing information held by the information management server 30 is acquired, the user need not perform an input operation for setting the attribute information. Needless to say, user input may be allowed, and arbitrary attribute information may be optionally included in the automatically collected attribute information. It is to be noted that when information on the multifunction device 10, such as a scanner installation place related to the document reading, is set in each multifunction device 10, internal information may be used. Therefore, the information need not necessarily be acquired from the information management server 30.

In addition, because the paper document scanned in the present embodiment contains data or the like for use in the conference, it is convenient to specify the conference for which the scanned document is used. As an example method of specifying the conference, the attribute information production processing unit 12 may list and display in a liquid crystal panel of the multifunction device 10 one or plural conference names which the user has, sent from the information management server 30, so that the user can select the conference name from the displayed list. Alternatively, in the information management unit 32, the conference which the user is attending or has just attended is specified from a status of the conference registered in the conference information and the user's present location specified by the user ID, and only the specified conference is sent to the multifunction device 10. In this manner, the scanned document can be associated with the conference in the multifunction device 10. Thus, the scanned document and the conference for which the document is used can be specified uniquely. The “conference” included in the attribute information by the attribute information production processing unit 12 is only one example of a conference specified in this manner.

In step 140, the registration information processing unit 13 adds the attribute information produced by the attribute information production processing unit 12 at the step 130 to the scanned document read in the step 120 to produce registration information. The information is sent to the scanned document management server 40. It is to be noted that, order in which the steps 120 and 130 are performed is not limited as described above. They may be performed in a reverse order, or simultaneously or in parallel with each other, before the step 140 is performed.

The scanned document information management unit 42 in the scanned document management server 40 registers the document registration information sent from the multifunction device 10 in the scanned document information storage unit 41. FIG. 5 shows an example constitution of the data of the scanned document information registered in the scanned document information storage unit 41. In FIG. 5, “document ID” is document identification information which specifies the scanned document. In the present embodiment, the storage location of the scanned document is set and registered as the document ID. “Scanning location”, “scanning date”, “conference”, and “owner” are associated with this document ID and registered for each registration information. The “scanning” location indicates where the document was scanned, and installation place information of the multifunction device 10 is set. To “owner”, user ID is set.

As described above, in the document scanning processing in the present embodiment, the attribute information can be automatically added to the scanned document in response to the reading operation of the card reader 3 and the document. Subsequently, scanned document acquiring processing in the present embodiment will be described with reference to the flowchart shown in FIG. 5. The processing is performed when a user other than the document owner (document reader) acquires the scanned document from a place other than the location at which the document was read.

In step 210, a user other than a document owner recognizes that the document reading operation in the multifunction device 10 has completed, and allows the card reader 4 to read the user's IC card 6 for a purpose of acquiring the document. The card reader is connected to the information terminal device 20 installed in the conference room where the user is present at that point. After reading the user ID recorded in the IC card 6, the card reader 4 sends the user ID to the information terminal device 20. The user ID acquisition processing unit 21 of the information terminal device 20 acquires the user ID sent from the card reader 4 in this manner.

In step 220, the request information production processing unit 22 transmits the information acquisition request including the acquired user ID to the information management server 30.

When the information acquisition request is sent, the information management unit 32 in the information management server 30 searches the user information registered in the database 31, using the user ID as the key, to find the ID of a conference which the user has. The conference name specified by the conference ID is acquired and the acquired information is returned to the information terminal device 20. It is to be noted that, because the location at which the information terminal device 20 is installed can be stored in the information management server 30, the user's present position can be updated by the user ID sent from the information terminal device 20.

When the information is sent from the information management server 30 in response to the request, the request information production processing unit 22 in the information terminal device 20 specifies only one conference with reference to the conference included in the information. This is done to specify what conference is to be held in the conference room in which the user is now located, in other words, to specify the conference that the user should attend. Moreover, when the conference is specified, the scanned document to be acquired from the information management server 30 can be specified. Here, when the user has a single conference to attend only, the conference can be uniquely specified. On the other hand, when the user has multiple conferences, the request information production processing unit 22 lists and displays a plurality of conference names in a display of the information terminal device 20, so that the user may select one name from the list. The user interface that displays the conference names may be constructed using existing technology. Even if the user does not select the information, it is possible to identify which conference is now being held in which conference room with reference to the conference information. However, there is a possibility that plural conferences that the user has are held simultaneously in parallel with one another and the user attends one of those conferences. Therefore, in the present embodiment, the user is allowed to select the one conference in such a manner as to contemplate any situation. It is to be noted that a scanned document can be specified by just user ID in a case where a document owner registers only one scanned document in the scanned document management server 40, and the document owner retrieves the scanned document.

Subsequently, the request information production processing unit 22 transmits the information acquisition request including the specified conference to the information management server 30.

When the information acquisition request is sent, the information management unit 32 in the information management server 30 searches the conference information registered in the database 31 by use of the conference as the key, retrieves the ID of the user which has the conference and location, and transmits this data to the information terminal device 20.

The request information production processing unit 22 in the information terminal device 20 acquires the attribute information for finding the corresponding scanned document from the scanned documents registered in the scanned document management server 40 by means of the information sent from the information management server 30 in response to the request. FIG. 7 shows an example constitution of the information acquired by the information terminal device 20. Through the above-described processing, there are acquired the place where the conference to be attended by the user is to be held, a document acquisition request date to set the present time which can be acquired from the information terminal device 20, the name of the conference, and the users who has the conference. The request information production processing unit 22 produces from the input user ID the document acquisition request information including the attribute information shown in FIG. 7.

In step 230, the document selection processing unit 23 specifies the scanned document to be acquired from the scanned documents stored in the scanned document management server 40 as follows. Respects to be considered in specifying the document will be described.

First, in this example, a user other than the document owner can acquire the document. Therefore, for example, there occurs a need that not only owner “u1” but also members of conference bodies “m1” and “m2” which the owner u1 has, be permitted to acquire the scanned document of the owner “u1”. “Conference location” (acquiring place of the scanned document) of the conference need not necessarily match with the document reading place in the same manner. On the other hand, because a conference is a subject to user the scanned document, “conference” included in the user information of “u1” and that of a user who acquires the document must correspond. As to date, when “scanning date” is close to a utilizing date, it is more likely that the document will be utilized. Therefore, combination of “location”, “conference name”, “member”, and date of request information may determine selected document. Therefore, in the present embodiment, the scanned document to be acquired can be specified as follows.

Assume that among attributes of the scanned document, a set of the “place” is P, a set of the “date” is T, a set of the “conference” is M, a set of the “user” constituting the conference is U; p ε P, t ε T, m ε M, and u ε U. The attribute of a set of four terms <p, t, m, u> is extracted with respect to individual scanned documents. Similarly, assuming that a set of user's sub-sets is S, and s ε S, the information terminal device 20 extracts the attribute of a set of four terms <p, t, m, s>. Here, it is assumed that the attributes of the scanned document are <p1, t1, m1, u1> and the attributes of the information terminal device 20 are <p2, t2, m2, s2>. Moreover, two functions δ and in are defined as follows:

δ(x, y)=0 or 1, wherein the function is 0 if x=y, and it is 1 if not;

in(u, s)=0 or 1, wherein the function is 0 if u ε s, and it is 1 if not.

Furthermore, a distance f of the scanned document is defined as follows:

f(<p1, t1, m1, u1>, <p2, t2, m2, s2>)=a*δ(p1, p2)+b*|t1−t2|+c*δ(m1, m2)+d*in(u1, s2),

wherein a, b, c, and d are weight coefficients which can be arbitrarily set by the user. In the present embodiment, as to the distance function f, distances between attribute values <p2, t2, m2, s2> held by the information terminal device 20 and attribute values <p1, t1, m1, u1> of the respective scanned documents stored in the scanned document management server 40 are calculated respectively. It is assumed that the scanned document for which the calculation result produces the smaller value is the scanned document to be acquired this time. That is, the calculated distance f is a function value indicating a relationship between the attribute information held by the information terminal device 20 and that of each scanned document stored in the scanned document management server 40. The smaller value indicates a larger degree of correlation (relation is stronger). That is, there is a high probability that the document corresponds to the scanned document desired this time.

Here, each term will be described. First, in the distance function f of the scanned document, a first term a*δ(p1, p2) concerning the “location” is 0, when the document acquiring location is the same as the document scanning location. The first term is 1, when the location is not the same. This location is calculated using geographic position information such as latitude, longitude, and altitude information, or a name (character string) uniquely applied to a place such as a specific conference room or a floor of a particular building. In this case, the scanning location of the document is not necessarily the same with the retrieval location, and dependency of this location on that attribute need not be weighted heavily. That is, a coefficient a is set to a small value. In the present embodiment, the function δ is used, but other functions, such as a function producing a numeric value proportional to a distance between the locations, may be used.

A second term b*|t1−t2| concerning the “date” is a term which depends on the time elapsed from the scanning of the document. For example, if u1 scans the data of a conference m which ended at 14:00 immediately after the end of the conference, and the scanned document is immediately utilized, the term indicates a small value. When a real-time property of the information is regarded as important, a large numeric value may be set to a coefficient b.

A third term c*δ(m1, m2) concerning the “conference” is 0, when the conference which the document owner has is the same as that which a document acquiring user has. The third term is 1, when the conferences are not the same. In this case, since it is presumed that the scanned document is conference data of a certain conference, the “conference” needs to be the same. Therefore, a significantly large numeric value is set to a coefficient c.

The fourth term d*in(u1, s2) concerning the “user” is a term which depends on the conference members. To an attribute value s2 of the “user” held by the information terminal device 20, one or more members of a conference are set. In this case, because it is presumed that the scanned document is conference data of a certain conference, only members of the conference are allowed access to the data. Therefore, a very large numeric value is set to a coefficient d.

The document selection processing unit 23 calculates the distance f of each scanned document, comparing the attributes <p2, t2, m2, s2> owned by the information terminal device 20 with the attributes <p1, t1, m1, u1> of the scanned document stored in the scanned document management server 40 as described above. Moreover, the scanned documents are listed and displayed in the information terminal device 20 in ascending order of distance. Specifically, on the screen is displayed the attribute information of each scanned document retrieved from the scanned document management server 40 during the calculation of the distance f. Because the documents are displayed in ascending order of distance f as described above, the scanned document to be acquired by the user usually must be near the top of the list for the user to easily find the scanned document to be acquired. Because the document selection processing unit 23 allows the user to select the scanned document in this manner, a scanned document acquired by the user can be specified.

In step 240, the scanned document acquisition processing unit 24 retrieves the scanned document corresponding to the specified attribute information of the scanned document from the scanned document management server 40. In this manner, the user can download the targeted scanned document into the information terminal device 20.

In the above description, the scanned documents are prioritized, listed, and displayed so that the user may select a target document. However, for security reasons, there may be a case in which it may be better not to display all of the scanned documents as selection candidates. Therefore, for example, a threshold value may be set to the distance f, and a scanned document exceeding this threshold value cannot be selected from the list, or is not displayed on the list. For example, when a value that exceeds this threshold value is preset to the coefficient d with respect to a user “u” in the distance function f, even existence of a scanned document can be kept from the user “u”. The strength of the security can be easily adjusted simply by changing the weight coefficient included in the distance function f in this manner. Although it has been described earlier, in the description of the distance function f, that the weight coefficients a to d can be arbitrarily set by the user, the range of values settable as the weight coefficients may be limited in terms of security.

Moreover, although in the present embodiment four items of attribute information including the user information, the location information, and the like are included in the document acquisition request information, it is not necessary that the four pieces of attribute information always be combined, but the information may be combined and used as appropriate. For example, just the user ID may be used when the same user uses a document at one location, as described above.

Also as described above, according to the present embodiment, the scanned document management system executes the processing when a document is acquired, in response to the reading operation of the IC card 6 from the user's card reader 4.

According to the present embodiment, the document data can be downloaded into the PC 20 without requiring that information of the type of multifunction device 10 and the address, without driver software, and without utilizing any confidential box. Especially, in the present embodiment, although the document owner can still load the document into the information terminal device 20 at the location the document is read, as described above in the example, users other than the owner can also retrieve the target scanned document from a different location, also as described above in the example. When the information management server 30 effectively utilizes the held existing information, the attribute information can be added to the scanned document without causing the user to perform an operation, such as a manual input operation.

It is to be noted that although in the example of the present embodiment the information terminal device 20 is provided with the document selection processing unit 23 to specify the scanned document in the information terminal device 20, a constitution in which the attribute information <p2, t2, m2, s2> of the information terminal device 20 is sent to the scanned document management server 40, and specifying the scanned document is performed by the scanned document management server 40 may also be employed. With such a configuration, the size of the attribute information to be transferred between the information terminal device 20 and the scanned document management server 40 can be reduced. Also, the document selection processing unit 23 need not be installed on each information terminal device 20.

In the present embodiment, a computer within the multifunction device 10 is used as the document scanning computer. The device for scanning a document includes the scanner mounted on the multifunction device 10, and the card reader 4 connected to the multifunction device 10, but a general-purpose PC may be connected to the scanner and the card reader 3 to constitute the device. Similarly, although the user identification information reading unit is constituted by the card reader 3 which reads the user ID from the user IC cards 5 and 6 in the above example, the scanner function of the multifunction device 10 may be utilized. The constitution of the user identification information reading unit can be varied as appropriate in consideration of a recording medium of the user ID. This applies to not only the document scanning device, but also the information terminal device 20 and the like.

Moreover, although the present embodiment has been described using an example in which the scanned document management system is applied to an electronic conference system, the present invention is not limited to use with electronic conferences, and is applicable to any system in which a scanned and digitized document is handled.

According to an aspect of the present invention, the request information transmitted by the request information transmission unit may include information on a group to which the user who requests the document belongs.

According to another aspect of the present invention, the request information transmitted by the request information transmission unit may include information on a place of a computer which the user who requests the document is using.

According to a further aspect of the present invention, when the user belongs to a plurality of groups, the request information producing unit may display group information on a screen, and may allow the user to select one group.

According to a further aspect of the present invention, there may be provided the document selection processing unit sets priority to the document data related to the user who requires a registered document, based on a difference between information included in the request information and attribute information of the document data, and shows the user the set priority to allow the user to select document data to get.

According to a further aspect of the present invention, there may be provided the document input unit is included in a computer mounted on a multifunction device, and realized by a scanner function.

According to a further aspect of the present invention, the system may be an electronic conference system.

According to a further aspect of the present invention, when the user who instructs to input a document belongs to a plurality of groups, the attribute information generating unit may display group information and allows the user to select one group, and the attribute information generated by the attribute information generating unit includes information of the selected group.

According to a further aspect of the present invention, the stored information of the user may include information of a meeting that that user joins, a member of the meeting, a place of the meeting, and schedule of the meeting.

This application claims priority under 35 USC 119 from Japanese patent document, 2005-130993, the disclosure of which is incorporated by reference herein.

1. A document management system comprising:
an information management unit that stores information regarding a user;
a document input unit that inputs a document according to an instruction from a user;
a first identification information acquiring unit that acquires identification information of the user who instructs to input the document;
an attribute information generating unit which generates attribute information of the input document, the attribute information including at least one of the acquired user identification information and the stored user information;
a document registration unit which registers the generated attribute information and the input document data;
a second identification information acquiring unit that acquires identification information of a user who requires a registered document;
a request information transmission unit which transmits request information including at least one of the acquired user identification information and user information stored in the information management unit; and a document provision unit which provides document data related to the user based on the request information and the attribute information of the document data.

2. The document management system according to claim 1, wherein the request information transmitted by the request information transmission unit includes information on a group to which the user who requests the document belongs.

3. The document management system according to claim 1, wherein the request information transmitted by the request information transmission unit includes information on a place of a computer which the user who requests the document is using.

4. The document management system according to claim 2, wherein, when the user belongs to a plurality of groups, the request information producing unit displays group information on a screen, and allows the user to select one group.

5. The document management system according to claim 1, wherein the document provision unit sets priority to the document data related to the user who requires a registered document, based on a difference between information included in the request information and attribute information of the document data, and shows the user the set priority to allow the user to select document data to get.

6. The document management system according to claim 5, wherein
the document input unit is included in a computer mounted on a multifunction device, and realized by a scanner function.

7. The document management system according to claim 6, which is an electronic conference system.

8. A document management method comprising:
storing information regarding a user;
inputting a document according to an instruction from a user;
acquiring identification information of the user who instructs to input the document;
generating attribute information of the input document, the attribute information including at least one of the acquired user identification information and the stored user information;
registering the generated attribute information and the input document data;
acquiring identification information of a user who requires a registered document;
transmitting request information including at least one of the acquired user identification information and user information stored in the information management unit; and
providing the document data related to the user based on the request information and the attribute information of the document data.

9. A read document management method comprising:
storing information regarding a user;
inputting a document according to an instruction from a user;
acquiring identification information of the user who instructs to input the document;
generating attribute information of the input document, the attribute information including at least one of the acquired user identification information and the stored user information;
registering the generated attribute information and the input document data;
acquiring identification information of a user who requires a registered document;
transmitting request information including at least one of the acquired user identification information and user information stored in the information management unit; and
providing the document data related to the user based on the request information and the attribute information of the document data.

10. A storage medium readable by a computer, the storage medium storing a program of instructions executable by the computer to perform a function as a document management server, the function comprising:
storing information regarding a user;
inputting a document according to an instruction from a user;
acquiring identification information of the user who instructs to input the document;
generating attribute information of the input document, the attribute information including at least one of the acquired user identification information and the stored user information;
registering the generated attribute information and the input document data;
acquiring identification information of a user who requires a registered document;
transmitting request information including at least one of the acquired user identification information and user information stored in the information management unit; and
providing the document data related to the user based on the request information and the attribute information of the document data.

11. The document management system according to claim 1, wherein
when the user who instructs to input a document belongs to a plurality of groups, the attribute information generating unit displays group information and allows the user to select one group, and
the attribute information generated by the attribute information generating unit includes information of the selected group.

12. A document management system comprising:
a document input unit that inputs a document along with information of a user who instructs the input;
a document storage unit that stores the input document and the information of the user;
a document requiring unit that requires a stored document which is related to a requiring user, using information of the requiring user; and
a document provision unit that provides the requiring user with the document related to the requiring user based on the stored user information and information of the requiring user.

13. The document management system according to claim 12, wherein the stored information of the user includes information of a meeting that that user joins, a member of the meeting, a place of the meeting, and schedule of the meeting.

14. A document management server comprising:
a document storage unit that stores document data and information of a user who input the document data; and
a document provision unit that receives a request from a user for a stored document which is related to the requesting user, and provides the requiring user with a document related to the requiring user based on the stored user information and information of the requiring user.
